(19) United States
(12) Patent Application Publication
(10) Pub. No.: US 2026/0350358 A1
(43) Pub. Date: Nov. 5, 2026

(54) METHODS AND SYSTEMS FOR IMPLEMENTING DYNAMIC NEURAL NETWORKS

(71) Applicant: APPLIED BRAIN RESEARCH INC., Waterloo (CA)

(72) Inventors: Aaron Russell VOELKER, Stittsville (CA); Christopher David ELIASMITH, Waterloo (CA)

(21) Appl. No.: 19/723,965

(22) Filed: Jun. 29, 2026

Related U.S. Application Data
(63) Continuation of application No. 17/556,466, filed on Dec. 20, 2021, now abandoned.
Application No. 17/556,466 is a continuation of application No. 15/243,223, filed on Aug. 22, 2016, now Pat. No. 11,238,337.

(51) Int. Cl. G06N 3/045; G06F 17/17; G06F 18/2135; G06N 3/049; G06N 3/063; G06N 3/10; G06N 20/00

(52) U.S. Cl. CPC G06N 3/045; G06N 3/049; G06F 17/17; G06F 18/2135; G06N 3/063; G06N 3/10; G06N 20/00

(57) ABSTRACT

A method is described for designing systems that provide efficient implementations of feedforward, recurrent, and deep networks that process dynamic signals using temporal filters and static or time-varying nonlinearities. A system design methodology is described that provides an engineered architecture. This architecture defines a core set of network components and operations for efficient computation of dynamic signals using temporal filters and static or time-varying nonlinearities. These methods apply to wide variety of connected nonlinearities that include temporal filters in the connections. Here we apply the methods to synaptic models coupled with spiking and/or non-spiking neurons whose connection parameters are determined using a variety of methods of optimization.

### CROSS-REFERENCE TO RELATED APPLICATIONS

This application is a continuation of application Ser. No. 17/556,466 filed Dec. 20, 2021, which is a continuation of application Ser. No. 15/243,223 filed Aug. 22, 2016 (now U.S. Pat. No. 11,238,337), which is incorporated by reference herein in its entirety.

### FILED OF THE INVENTION

The invention relates generally to computing using single or multi-layer networks; and more particularly to a system and method for providing feed-forward, recurrent, and deep networks that process dynamic signals using temporal filters and static or time-varying nonlinearities.

### BACKGROUND

The majority of artificial neural networks (ANNs) in use today are applied to static inputs (e.g., images). However, processing dynamic inputs (e.g., movies, sound, sensory feedback) is critical for real-time interaction with the world in domains such as manufacturing, auditory processing, video processing, and robotics. Non-ANN prior art methods for processing dynamic inputs occasionally rely on future information for processing a current state. This is sometimes called “acausal” filtering, and is typically physically implemented using delays (i.e. waiting until the future information is available before computing a response). Other state-of-the-art methods for processing dynamic inputs include nonlinear filtering, in which the output is not a linear function of the input. Both of these kinds of filtering are challenging for ANNs to realize. Currently, a dominant approach to processing temporal information in ANNs is to employ Long, Short-Term Memories (LSTMs; see S. Hochreiter and J. Schmidhuber, Long short-term memory. Neural Computation, vol. 9, no. 8, pp. 1735-1780 November 1997.). LSTMs rely solely on recurrent connections to process information over time with no synaptic filtering.

Another class of dynamic ANNs are those that employ “reservoir computing” (RC; see M. Lukoševičius and H. Jaeger, Reservoir computing approaches to recurrent neural network training. Computer Science Review, vol. 3, no. 3, pp. 127-149, August 2009.). Reservoir ANNs randomly connect large numbers of nonlinear nodes (i.e., neurons) recurrently, and then optimize (i.e., ‘learn’) a linear readout to perform dynamic signal processing. A neuron is said to be ‘spiking’ if its output consists of brief temporal pulses of output in response to its input. If the nodes in the reservoir are non-spiking (i.e., rate neurons), the method is called an Echo State Network (ESN; see H. Jaeger, The echo state approach to analysing and training recurrent neural networks. German National Research Center for Information Technology Technical Report, vol. 148, p. 34, January 2001.). LSTMs and the majority of other ANNs use rate neurons. There are a variety of methods for determining the connection weights between neurons in these networks, including gradient descent on the output connection weights, the First-Order Reduced and Controlled Error (FORCE; see D. Sussillo and L. F. Abbott, Generating coherent patterns of activity from chaotic neural networks. Neuron, vol. 63, no. 4, pp. 544-557, August 2009.) method on feedback connections, and unsupervised, error-driven Hebbian learning rules on the recurrent connections. Like LSTMs, ESNs and related methods rely solely on recurrent connections to process information over time. If the reservoir in an RC network uses spiking nodes, then the method is called a Liquid State Machine (LSM; see W. Maass, T. Natschläger, and H. Markram, Real-time computing without stable states: A new framework for neural computation based on perturbations. Neural Computation, vol. 14, no. 11, pp. 2531-2560 November 2002.). Liquid state machines are trained (i.e., optimized) in a similar manner to ESNs. Because of the spiking temporal representation, LSMs typically introduce a temporal filter (i.e., synapse) on the input to the nodes. This is most commonly a low-pass filter (i.e., decaying exponential), which smooths the spiking input before driving the neural non-linearity. LSMs usually use the same linear filter on all neurons, and they are usually first-order.

A different approach to building spiking and non-spiking dynamic neural networks is the Neural Engineering Framework (NEF; see C. Eliasmith and C. Anderson, Neural engineering: Computation, representation, and dynamics in neurobiological systems. MIT Press, 2003.). In this approach, the dynamics of the network are optimized to approximate a given function. This can be thought of as directly optimizing the “reservoir” in RC networks. The optimization can be done directly using a global optimizer, or during run-time using any of several learning rules. These networks usually assume a first-order low-pass temporal filter (i.e., synapse) as well.

Prior art approaches to implementing dynamic neural networks either do not have a synaptic filter (e.g., LSTMs, ESNs), or pick a simple filter (e.g., LSMs, NEF networks). These approaches also assume that the same filter is used for the majority of synapses in the model.

### SUMMARY

In a first aspect, some embodiments of the invention provide a method for implementing single or multi-layer, feed-forward or recurrent neural networks for dynamic computations. The method includes defining any node response function that either exhibits brief temporal nonlinearities for representing state over time, often termed ‘spikes’, or exhibits a value at each time step or over continuous time (i.e., ‘rates’). These response functions are dynamic because they accept input over time and produce output over time. For spiking neurons, the nonlinearity is over both time and state, whereas for rate neurons it is largely over state. The method also includes defining one or more temporal filters (i.e., synapses) on the input and/or output of each node. These synapses serve to filter the input/output signal in various ways, either linearly or nonlinearly. This structure is then used to determine connection weights between layers of nodes for computing a specified dynamic function. Specification of the function can be performed either by writing it in closed form, or by providing sample points.

In some cases, the initial couplings and connection weights are determined using a neural compiler. Connection weights can be further trained either with online or offline optimization and learning methods.

In a second aspect, some embodiments of the invention provide a system for pattern classification, data representation, or signal processing in neural networks. The system includes one or more input layers presenting a vector of one or more dimensions, as well as zero or more intermediate layers coupled via weight matrices to at least one of the input, other intermediate, or output layers, and one or more output layers generating a vector representation of the data presented at the input layer or computing a function of that data. Each layer comprises a plurality of nonlinear components, wherein each nonlinear component has zero or more temporal filters on its input and zero or more temporal filters on its output, with one or more filters associated with each component, and the component coupled to the layer's input and output by at least one weighted coupling. The output from each nonlinear component's temporal filter is weighted by the connection weights of the corresponding weighted couplings and the weighted outputs arc provided to the layer's output. The input to each nonlinear component's temporal filter is weighted by the connection weights of the corresponding weighted couplings and the weighted and filtered inputs are provided to the component. The connection weights are determined using methods of the first aspect.

In some cases, the input to the system is either discrete or continuous in time and/or space.

In some cases, the input to the system can be scalar or a multidimensional vector.

### BRIEF DESCRIPTION OF THE DRAWINGS

A preferred embodiment of the present invention will now be specified in detail with reference to the drawings.

FIG. 1 is a block diagram of layers and nonlinear elements in accordance with an example embodiment.

FIG. 2 is a diagram of the process involved in applying the method.

FIG. 3 shows an embodiment computing a 100 ms delay with spiking neurons.

FIG. 4 shows improved accuracy of these methods over state-of-the-art methods.

FIG. 5 shows improved computational costs compared to state-of-the-art methods.

FIG. 6 shows an embodiment computing the acausal derivative filter.

FIG. 7 shows an embodiment with a controllable delay.

FIG. 8 shows an embodiment computing ten different delays within one network.

FIG. 9 shows results of computing the Fourier transform power, a nonlinear dynamic computation.

FIG. 10 shows trajectory generation using a controllable delay bank.

FIG. 11 is a diagram of an abstract characterization of the system with an arbitrary synaptic filter.

FIG. 12 shows improved accuracy in delay computation by including higher-order synapses.

FIG. 13 is a diagram of an abstract decomposition of the system into encoding and decoding filters.

FIG. 14 shows the ability to determine the optimal distribution of heterogeneous synapses to minimize error in computing a derivative.

### DESCRIPTION OF EXEMPLARY EMBODIMENTS

Herein, specific details are set forth in order to provide a thorough understanding of the exemplary embodiments described. However, it will be understood by those of ordinary skill in the art that the embodiments described herein may be practiced without these specific details. In other instances, well-known methods, procedures and components have not been described in detail so as not to obscure the embodiments generally described herein. Furthermore, this description is not to be considered as limiting the scope of the embodiments described herein in any way, but rather as merely describing the implementation of various embodiments as presented here for illustration.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices, in known fashion.

Each program may be implemented in a high-level procedural or object-oriented programming or scripting language, or both, to communicate with a computer system. Alternatively the programs may be implemented in assembly or machine language, if desired. The language may be a compiled or interpreted language. Each such computer program may be stored on a storage media or a device (e.g., read-only memory (ROM), magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer useable instructions for one or more processors. The medium may be provided in various forms, including one or more diskettes, compact disks, tapes, chips, magnetic and electronic storage media, and the like. Non-transitory computer-readable media comprise all computer-readable media, with the exception being a transitory, propagating signal. The term non-transitory is not intended to exclude computer readable media such as a volatile memory or random access memory (RAM), where the data stored thereon is only temporarily stored. The computer useable instructions may also be in various forms, including compiled and non-compiled code.

It should also be noted that, as used herein, the wording “and/or” is to mean inclusive-or. That is, “X and/or Y” is intended to mean X or Y or both, for example. As a further example, “X, Y, and/or Z” is intended to mean X or Y or Z or any combination thereof.

Embodiments described herein generally relate to a system and method for designing and implementing a feed-forward or recurrent neural network for dynamic computation. Such a system can be efficiently implemented on a wide variety of distributed systems that include a large number of nonlinear components whose individual outputs can be combined together to implement certain aspects of the system as will be described more fully herein below.

Examples of nonlinear components that can be used in various embodiments described herein include simulated/artificial neurons, field-programmable gate arrays (FPGAs), graphics processing units (GPUs), configurations of analog components and other physical primitives including but not limited to transistors, and/or other parallel computing systems. Components of the system may also be implemented using a variety of standard techniques such as by using microcontrollers.

The systems described herein can be implemented in various forms including soft-ware simulations (using standard languages (e.g. Python, C, etc.) and more specialized implementations (e.g. Open Computing Language (OpenCL), Message Passing Interface (MPI), etc.), hardware, and/or any neuronal fabric. Examples of neuronal fabric mediums that can be used to implement the system designs described herein include Neurogrid (see S. Choudhary, S. Sloan, S. Fok, A. Neckar, Eric, Trautmann, P. Gao, T. Stewart, C. Eliasmith, and K. Boahen, Silicon neurons that compute, in International Conference on Artificial Neural Networks, pp. 121-128, 2012.), SpiNNaker (see M. Khan, D. Lester, L. Plana, A. Rast, X. Jin, E. Painkras, and S. Furber, SpiNNaker: Mapping neural networks onto a massively-parallel chip multiprocessor. IEEE, June 2008.), and TrueNorth (see P. A. Merolla, J. V. Arthur, R. Alvarez-Icaza, A. S. Cassidy, J. Sawada, F. Akopyan, B. L. Jackson, N. Imam, C. Guo, Y. Nakamura, B. Brezzo, I. Vo, S. K. Esser, R. Appuswamy, B. Taba, A. Amir, M. D. Flickner, W. P. Risk, R. Manohar, and D. S. Modha, Artificial brains. A million spiking-neuron integrated circuit with a scalable communication network and interface. Science, vol. 345, no. 6197, pp. 668-673, August 2014.). As used herein the term ‘neuron’ refers to spiking neurons, continuous rate neurons, and/or components of any arbitrary high-dimensional, nonlinear, distributed system.

To generate such systems, the system dynamics can be characterized at a high level of description, using available background information regarding function. A low-level neural network structure can then be employed that includes a specific filter, or distribution of filters, on the inputs to the neurons in the network, and analytically relate the two. Subsequently, it is possible to optimize the connections between the elements in the neural network to accurately compute the desired function using standard optimization methods. The challenge this addresses is one of identifying and efficiently exploiting low-level dynamics and network structure at the functional level for dynamic information processing.

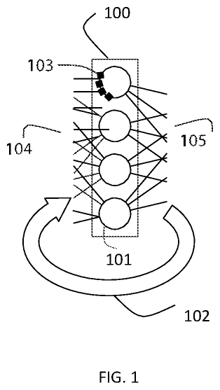

FIG. 1 shows the general architecture of a layer of these networks. Each layer (100) consists of several nodes (101) that can be either spiking or non-spiking. The overall network structure can be quite varied, with layers connecting within or back to themselves or to other layers earlier in the network (102; recurrent networks), or to layers later than them in the network. Networks that connect only in one direction are called feed-forward networks. Connections between layers may also be quite varied, including full connectivity, local connectivity, convolutional connectivity, or any other connectivity pattern known in the art. In addition, the networks considered introduce an explicit temporal filtering, some examples of which are denoted by black boxes (103), into the network. This filtering can take a variety of forms and be introduced in a variety of ways in each layer, including but not limited to same and/or different filters on inputs and/or outputs on each neuron, same and/or different filters on inputs and/or outputs on each dimension of the layer input/output vector (104, 105). Regardless of the topology, the overall network takes some form of vector input which it converts via its weighted, connected components to a different vector output, possibly changing the dimensionality. This figure represents the basic structure of the layers comprising the networks considered here.

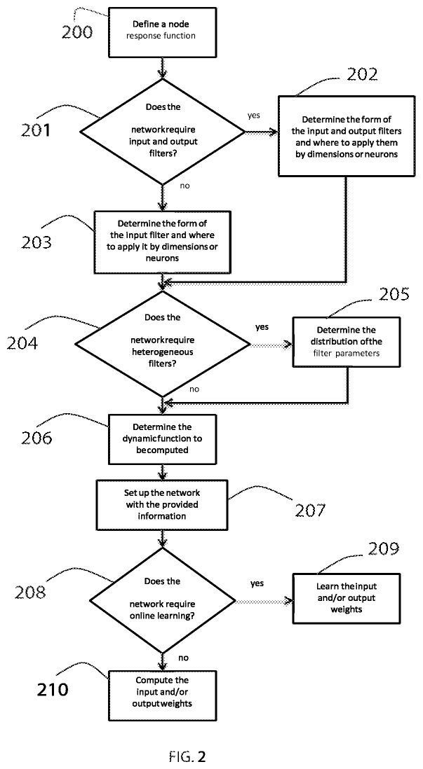

Referring now to FIG. 2, there is shown a method for implementing single or multi-layer, feed-forward or recurrent spiking neural network dynamic computations.

At step 200, the method defines any node response function that exhibits brief temporal nonlinearities for representing state over time, i.e., ‘spikes’ or node response functions that elicit values at each time, i.e., ‘rates’. There are a wide variety of example spiking nonlinearities in the literature, including the Hodgkin-Huxley neuron, the Fitzhugh-Nagumo neuron, the exponential neuron, the quadratic neuron, the theta neuron, the integrate-and-fire neuron, the leaky integrate-and-fire neuron, the Wilson neuron, and the Izhikevich neuron, among others. Similarly, there are a wide variety of example rate nonlinearities, such as the family of sigmoidal curves, the tanh function, and/or the rectified linear neuron. Various hardware implementations of these and other nonlinearities have also been proposed for generating spike-like or rate-like outputs, any of which can be employed.

Steps 201-203 determine a plurality of input and/or output filters to be associated with the layer inputs. There are a wide variety of filters in the literature, many of which are considered models of synaptic response, including the exponential decay ‘low-pass’, the delayed low-pass, the alpha synapse, the double exponential synapse, and conductance-based models. These filters can be applied to each neuron input and/or output, or to each dimension of the input and/or output space being manipulated by the layer, and may be heterogeneous, as indicated at steps 204, 205.

At step 206, the method determines the dynamic function that is to be computed by the network. This function can be specified in closed form or defined with a set of example inputs and/or outputs.

Step 207 includes employing the chosen network structure to compute the specified dynamic function by finding the correct input and output weights. The novel approach proposed here for finding the weights is described in detail for several example embodiments below. Optimization for the weights can be accomplished in a number of ways at step 208, including by direction optimization (e.g., as sometimes used in the NEF), by optimization based on example simulations of the network as per step 210, or using any of a variety of standard “learning rules” or optimization methods specified in the literature as per step 209. The proposed network construction method shows how these optimization methods can be effectively used for networks with the structure specified. With this method the weights determined in step four can be used in a dynamically implemented spiking or rate neural network to compute the function trained for. This consists in running the dynamic neural model, where each neuron is connected to others by the input/output filters weighted by the connection weights determined during optimization. As shown in the example embodiments, this set of steps allows for good performance on a wide variety of difficult dynamic computations.

In this method the input/output filters can be discrete or continuous. Many software and hardware implementations use discrete time steps to simulate dynamical systems or perform computation over time. As shown in the example embodiments, this method can account for discrete or continuous filtering. Accounting for discrete filtering can significantly improve the accuracy of discrete time step implementations.

In this method the optimization performed to determine the input/output weights can be performed either offline or online, determined in any of a number of ways. NEF methods fall into the former class, are very efficient and have strong convergence guarantees. In the example embodiments this is the most common method employed. However, some example embodiments use offline methods that require simulation of the network. Other work has shown how these same networks can be optimized using online methods as well (e.g., see T. Bekolay, Learning in large-scale spiking neural networks, Master's Thesis, University of Waterloo, September 2011.).

In this method the input/output weights can often be combined between layers to determine a single large connection weight matrix, as is more common in standard neural networks. This method can employ either factorized weights (i.e., separate input/output weights) or non-factorized weights (i.e., a single matrix). The optimization described can be performed on either factorized or non-factorized weights. Often factorized matrices are more computationally efficient to employ. The example embodiments use factorized matrices.

In this method the specified dynamic function can be continuously or discretely defined. Discretely defined functions are especially relevant for implementation of these methods in digital hardware and software.

In this method the specified dynamic function can be defined in a wide variety of ways. Most generally any linear or nonlinear differential equations in phase space can be specified. Identifying such systems can include, but is not limited to writing the equations in closed form, specifying a transfer function form, or providing a set of input/output point pairs. Similarly, any function specified as a pure delay or definable in terms of pure delays (e.g., a finite impulse response filters) can be employed. Subsequent example embodiments demonstrate a variety of these methods, including pure delays and a variety of functions defined in terms of pure delays, including differentiation and computing spectral power.

In this method the specified dynamic function can be a controllable pure delay or definable in terms of a controllable pure delay. A controllable pure delay is shown in an example embodiment. This is a nonlinear filter that allows the amount of delay to change as a function of its input. As with non-controlled delays and linear filters, controlled delays can be used to define an extremely wide variety of nonlinear temporal filters.

In this method Padé approximants can be used to implement the specified dynamic function, as can system identification methods. Padé approximants are a useful means of providing optimal approximations to filters defined over infinite states (like pure delays). An example embodiment demonstrates the use of this approximation for computing dynamic functions. Similarly, approximating complex dynamic functions can be performed by using numerical methods for system identification.

### Example Embodiment: A Causal Filtering

Past work has not demonstrated a general approach to performing acausal filtering in such networks. An acausal filter is a dynamical system that requires information from future times to determine the value of the filtered signal at the current time. Acausal filtering is important for a wide variety of dynamic signal processing, including performing differentiation, highpass filtering, distortion reversal (and/or any other deconvolution), predicting future states of the system, among many others. Acausal filtering is closely related to prediction because it requires making estimates of future states. The methods described in this section address this problem for dynamic neural networks.

To perform acausal filtering, we need to know information that is not yet available to the system. Consequently, we wait for a period of time to gather sufficient information, and then compute the desired filter. To successfully pursue this approach, it is essential to be able to compute delayed versions of the input signal. Past work has not demonstrated how to construct such delays accurately and in general. We begin by addressing how to compute delays in dynamic neural networks.

Linear time-invariant (LTI) systems can be described by the state equations:

\dot{x}(t)=Ax(t)+Bu(t)

y(t)=Cx(t)+Du(t) (1)
where the time-varying vector x represents the system state, y the output, u the input, and the time-invariant matrices (A, B, C, D) fully define the system dynamics. All causal finite-order LTI systems can be written in this form.

### Accurate Delays

In many scenarios, the transfer function is a more useful representation of the LTI system. The transfer function is defined as

$$\frac{{Y}_{( s )}}{U ( s )} ,$$

where Y(s) and U(s) are the Laplace transforms of output y(t) and input u(t) respectively. The variable s denotes a complex variable in the frequency domain, while t is a non-negative real variable in the time domain. The transfer function is related to the state-space representation (1) by the following equation:

$$F ( s ) = \frac{{Y}_{( s )}}{{U}_{( s )}} = {C ( sI - A )}^{- 1} B + D . \qquad ( 2 )$$

The transfer function for a pure delay of a seconds is:

F(s)=e^{-αs} (3)

A transfer function can be converted into state-space representation using (2) if and only if it can be written as a proper ratio of finite polynomials in s. The ratio is proper when the degree of the numerator does not exceed that of the denominator. In this case, the output will not depend on future input, and so the system is causal. The order of the denominator corresponds to the dimensionality of x, and therefore must be finite. Both of these conditions can be interpreted as physically realistic constraints where time may only progress forward, and neural resources are finite.

To approximate the irrational transfer function (3) as a ratio of finite polynomials, we use the Padé approximants of the exponential,

$$[ p / q ] {e}^{- α s} = \frac{{Q}_{p} ( - α s )}{{Q}_{q} ( α s )} \qquad ( 4 )$$

$${Q}_{k} ( s ) = {\sum }_{i = 0}^{k} ( \begin{matrix}k \\ i\end{matrix} ) \frac{( p + q - i ) !}{( p + q ) !} {s}^{i} . \qquad ( 5 )$$

This gives the optimal approximation for a transfer function with order p in the numerator and order q in the denominator. After choosing suitable values for p≤q, we can numerically find a state-space representation (A, B, C, D) that satisfies (2) using standard methods.

For the common case that p=q−1, we may bypass the need for any numerical methods by analytically finding a simple state-space representation. Consider the Padé approximants of (3) in the case where q−1 and q are the order of the numerator and denominator, respectively. We rewrite (4) by expanding (5) to get:

$$\begin{matrix}[ q - 1 / q ] {e}^{- α s} = \frac{{\sum }_{i = 0}^{q - 1} ( \begin{matrix}q - 1 \\ i\end{matrix} ) ( 2 q - 1 - i ) ! {( - 1 )}^{i} {α}^{i} {s}^{i}}{{\sum }_{i = 0}^{q} ( \begin{matrix}q \\ i\end{matrix} ) ( 2 q - 1 - i ) ! {α}^{i} {s}^{i}} \\ = \frac{\frac{1}{{α}^{q} ( q - 1 )} {\sum }_{i = 0}^{q - 1} \frac{( q - 1 ) !}{( q - 1 - i ) ! i !} ( 2 q - 1 - i ) ! {α}^{i} {{s}^{i} ( - 1 )}^{i}}{{s}^{q} + \frac{1}{{α}^{q} ( q - 1 )} {\sum }_{i = o}^{q - 1} \frac{q !}{( q - i ) ! i !} ( 2 q - 1 - i ) ! {α}^{i} {s}^{i}} \\ = \frac{{\sum }_{i = 0}^{q - 1} {c}_{i} {s}^{i}}{{s}^{q} + {\sum }_{i = 0}^{q - 1} {d}_{i} {s}^{i}}\end{matrix} ,$$

where

$${d}_{i} = \frac{q ( 2 q - 1 - i ) !}{( q - i ) ! i !} {α}^{i - q} and {c}_{i} = {d}_{i} ( - 1 ) \frac{i ( q - i )}{q} .$$

This transfer function is readily converted into a state-space representation in controllable canonical form:

$$A = ( \begin{matrix}- {d}_{q - 1} & - {d}_{q - 2} & … & - {d}_{0} \\ 1 & 0 & … & 0 \\ 0 & ⋱ & ⋱ & ⋮ \\ … & 0 & 1 & 0\end{matrix} )$$

$$B = {( 100 )}^{T}$$

$$C = ( {c}_{q - 1} {c}_{q - 2} … {c}_{0} )$$

$$D = 0.$$

However, the factorials in dᵢ and cᵢ may introduce numerical issues. To simplify implementation we scale the i^{th} dimension of x by −d_{q-i}. This is achieved without changing the transfer function by multiplying the j^{th} entry in B by −d_{q-j}, the i^{th} entry in C by −1/d_{q-i}, and the (i, j)^{th} entry in A by d_{q-i}/d_{q-j}, to obtain the equivalent state-space representation,

$$A = ( \begin{matrix}- {v}_{0} & - {v}_{0} & … & - {v}_{0} \\ {v}_{1} & 0 & … & 0 \\ 0 & ⋱ & ⋱ & ⋮ \\ ⋮ & 0 & {v}_{q - 1} & 0\end{matrix} ) \qquad ( 6 )$$

$$B = {( - {v}_{0} 0 … 0 )}^{T}$$

$$C = ( {ω}_{0} {ω}_{1} … {ω}_{q - 1} )$$

$$D = 0 ,$$

where

$${v}_{i} = \frac{( q + i ) ( q - i )}{( i + 1 ) α} and {ω}_{i} = {( - 1 )}^{q - i} \frac{( i + 1 )}{q} , for i = 0 … q - 1 .$$

This follows from noting that v₀=d_{q-1} and vᵢ=d_{q-i-1}/d_{q-1} for i≥1. This provides an exact solution for the Padé approximation of the delay.

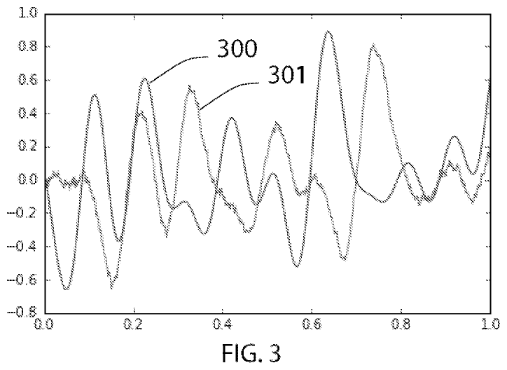

With this description we can use the NEF methods to generate an example embodiment. FIG. 3 shows the results of performing a 100 ms delay on a random 10 Hz white noise signal with 400 spiking neurons using a first-order low-pass synaptic filter with a time constant of 5 ms. It is using a 4^{th}-order approximation. The original input signal (300) is delayed and decoded (301) from the neural spikes generated by the recurrently connected neurons.

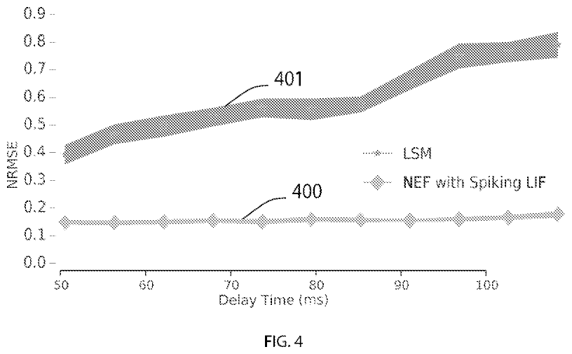

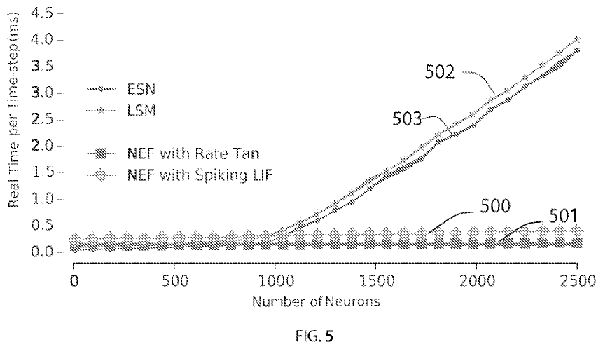

Furthermore, these methods are significantly more accurate and far less computationally expensive than other state-of-the-art methods. Specifically, FIG. 4 demonstrates that in a network of 500 neurons computing delays from 50-100 ms on 8 Hz white noise, the NEF methods (400) are 4× or more accurate than a liquid state machine (LSM), which is the spiking implementation of reservoir computing (401). Rate mode versions of NEF compared to an echo state network (ESN), which is the non-spiking implementation of reservoir computing, have the same accuracy. However, as shown in FIG. 5 spiking and rate NEF networks are a factor O (N) cheaper to compute (500, 501), with N as the number of neurons, because of their factored weight matrices compared to reservoir methods (502, 503).

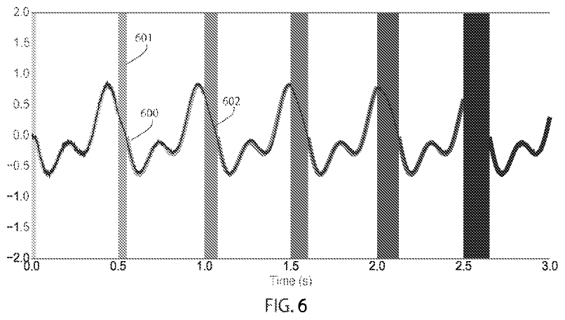

Another embodiment of the delay network allows us to introduce controlled delay into the network by noting that in (6) all terms in the feedback A matrix arc a function of α. Consequently, we can introduce an input that provides α on-the-fly, controlling the delay online. This input is encoded into the state-space x and the product is computed in the recurrent connection. FIG. 6 is the same as the previous embodiment, but with 2000 spiking neurons and a controllable input. The original input signal (600) is delayed by an amount controlled by the delay input (601) which changes from 25 ms to 150 ms in steps of 25 ms in this figure (delay length is indicated by the shaded bars). The delayed signal (602) is decoded from the neural spiking activity.

### Acausal Filtering Examples

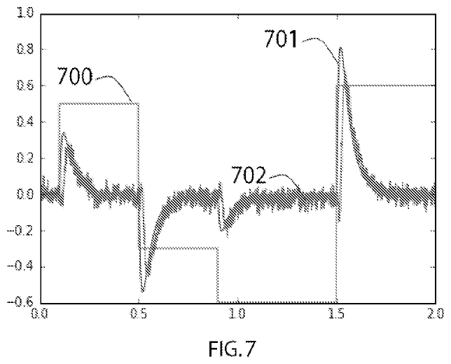

An accurate method for generating a delayed version of a signal provides the basis for general acausal filtering. One embodiment of an acausal filtering network is the network that computes the derivative of the input signal. FIG. 7 shows the behaviour of a 400 neuron network that implements the acausal differentiation transfer function F(s)=τs using a delay of 15 ms. The input signal (700) and the ideal derivative filter (701) are shown along with the decoded output (702) of the spiking recurrent neural network computation of that filter using a delay. Since the output is spikes, we filter it with a low-pass filter. The end result is therefore the highpass filter,

$$F ( s ) = \frac{τ s}{τ s + 1} ,$$

which smooths out the derivative. In this example τ=50 ms.

This embodiment network is one example of a general (acausal) deconvolution net-work with the specific transfer function

$$F ( s ) = \frac{1}{τ s} .$$

Deconvolution can be instantiated with any LTI that one wishes to invert, provided the delayed inverse can be accurately approximated.

To perform more complex acausal filtering, we need to generate many delayed versions of the input signal. It is known that any finite impulse response filter can be approximated by a weighted sum of delays. Consequently, another embodiment consists of creating many different delays in a network and weighting those to compute the filter. Such a delay bank is very flexible for computing a wide variety of dynamic functions using neural networks. Determining the output weights on the filter bank can be done using a wide variety of methods that employ either online or offline learning or optimization. More generally, such a filter bank allows for nonlinear combinations of delays and represented states.

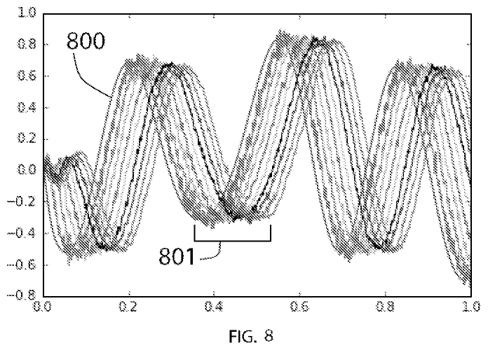

FIG. 8 shows the output of a network instantiating a bank of delays separated by 15 ms each. The input signal (800) is a 10 Hz white noise signal and the output includes 9 delayed versions of that signal (801), computed with 5400 spiking neurons using 3rd-order delay approximations.

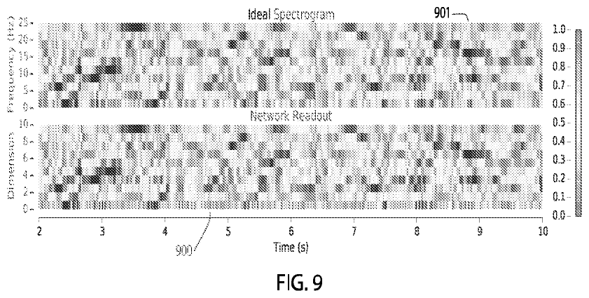

An example embodiment that employs a filter bank and is performing nonlinear filtering is demonstrated in FIG. 9. This network is computing the power of the Fourier transform at 10 frequencies (900) which is compared to the ideal computation (901). The input signal is random 25 Hz white noise, and the network employs 22800 rate neurons with 20 delays spaced by 20 ms where p=q=40.

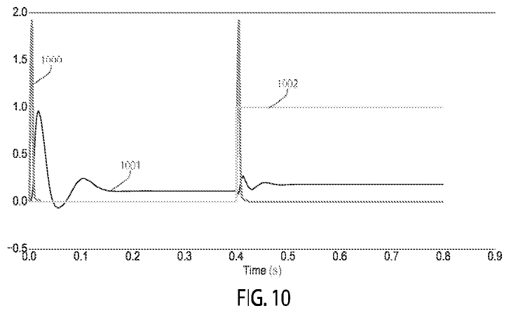

The next embodiment we consider uses controlled delay and an arbitrary filter to perform trajectory generation is shown in FIG. 10. In this case, the input is a delta function and the output is an arbitrary trajectory over time, defined by the shape of the filter. The input (1000) causes the system to play back the trajectory (1001) using the delay bank. The speed and size of playback can be controlled by the delay input (1002) as shown. This example shows the same trajectory played ‘big’ and ‘small’ given the same delta function input, but for a different delay control input.

### Example Embodiment: Arbitrary Synaptic Filters

### Method 1: Using Taylor Series Approximations

Past work has not shown how to account for arbitrary synaptic filters in the implemented neural network. The NEF has demonstrated how to account for the special case of a first-order low-pass filter. The methods described in this section address the general problem. Some of these modifications improve network accuracy and reduce the number of network elements needed to perform a given computation effectively. These modifications also allow the efficient use of a wider variety of discrete and continuous synaptic filters.

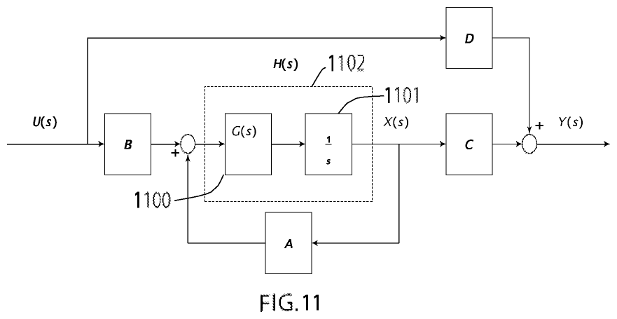

Referring to FIG. 11 we consider appending some arbitrary transfer function G(s) (1100) to the feedback, so as to replace the integrator

$$\frac{1}{s} ( 1101 )$$

with

$$H ( s ) = G ( s ) \frac{1}{s} ( 1102 ) .$$

This system has transfer function

$${C ( \frac{S}{G ( s )} I - A )}^{- 1} B + D = F ( \frac{S}{G ( s )} ) = F ( \frac{1}{H ( s )} ) ,$$

where F(s)=C(sI−A)⁻¹B+D is the transfer function for (A, B, C, D).

To invert the change in dynamics introduced by appending G(s), we must compensate for the change of variables

$$\frac{s}{G ( s )}$$

in the complex frequency domain. This involves finding the required F′(s) such that

$${F}^{′} ( \frac{1}{H ( s )} )$$

is equal to the desired transfer function, F(s). Then the state-space representation of F′(s) provides (A′, B′, C′, D′) which implement the desired dynamics.

For example, if we replace the integrator with a low-pass filter, so that

$$h ( t ) = \frac{1}{τ} {e}^{- \frac{t}{τ}} ,$$

and set G(s) to unity then:

F′(s)=C(sI−(τA+I))⁻¹(τB)+D=C′(sI−τA′)⁻¹B′+D′,
which is an alternative derivation of the mapping given by NEF methods. However, this is the only form of H(s) solved for by the NEF. We extend this result to apply to a wider variety of filters. For instance, in the case of the alpha synapse model where

$$H ( s ) = \frac{1}{{( 1 + τ s )}^{2}}$$

we can show that:

F′(s)=C(√sI−(τA+I))⁻¹(τB)+D.

Notably, this embodiment is nonlinear in s. We can use the Taylor series expansion

$$\sqrt{s} = 1 + \frac{1}{2} ( s - 1 ) + o ( s )$$

to linearize √s in our characterization of F′(s), giving

F′(s)=C(sI−(2τA+I))⁻¹(2τB)+D.

Another example embodiment is the case of a discrete low-pass filter with a z-transform of

$$H ( z ) = \frac{1 - a}{z - a} , a = {e}^{- \frac{dt}{τ}} ,$$

$${F}^{′} ( \frac{z - a}{1 - a} ) = F ( z ) \qquad ( 7 )$$

$$\begin{matrix}⇔ {F}^{′} ( z ) = F ( z ( 1 - a ) + a ) \\ = \overline{C} ( ( z ( 1 - a ) + a ) {( I - \overline{A} )}^{- 1} \overline{B} + \overline{D} \\ = {\overline{C} ( z I - \frac{1}{1 - a} ( \overline{A} - a I ) )}^{- 1} ( \frac{1}{1 - a} \overline{B} ) + \overline{D}\end{matrix}$$

$$⇒ ( {\overline{A}}^{′} , {\overline{B}}^{′} , {\overline{C}}^{′} , {\overline{D}}^{′} ) = ( \frac{1}{1 - a} ( \overline{A} - aI ) , \frac{1}{1 - a} \overline{B} , \overline{C} , \overline{D} ) ,$$

where (Ā, B̅, C̅, D̅) is the result of discretizing (A, B, C, D) with time step dt. Discrete filters are particularly relevant for hardware implementations which are clocked at a specific frequency, and hence have a built in dt, or software implementations that use a time step to approximate continuous dynamics. This embodiment can make such implementations more accurate.

A further example embodiment is one which compensates for a continuous feed-back delay of β seconds, by setting G(s)=e^{-βs}, then

$${F}^{′} ( \frac{s}{{e}^{- β s}} ) = F ( s ) ⇔ {F}^{′} ( s ) = F ( \frac{1}{β} {W}_{0} ( β s ) ) \qquad ( 8 )$$

where W₀(xe^{x})=x is the principle branch of the Lambert-W function, since

$${F}^{′} ( {se}^{β s} ) = F ( \frac{1}{β} {W}_{0} ( β {se}^{β s} ) ) = F ( s ) .$$

In this case, since W₀ is nonlinear in s, the effect of the change of variables on the required state-space representation will depend on the desired transfer function F.

For this embodiment we consider the case of a synapse modeled by a low-pass filter with a pure delay of β seconds, to account for possible transmission time delays along presynaptic axons. In this instance,

$$H ( s ) = \frac{{e}^{- β s}}{τ s + 1} ,$$

and let

$$d = \frac{β}{τ} {e}^{\frac{β}{τ}} .$$

We can then show

$${F}^{′} ( \frac{τ s + 1}{{e}^{- β s}} ) = F ( s ) ⇔ {F}^{′} ( β s + \frac{β}{τ} ) {e}^{( β s + \frac{β}{τ} )} = F ( \frac{β}{τ} {e}^{\frac{β}{τ}} s ) ⇔ {F}^{′} ( β s + \frac{β}{τ} ) = F ( {W}_{0} ( ds ) ) ⇔ {F}^{′} ( s ) = F ( \frac{1}{β} {W}_{0} ( ds ) - \frac{1}{τ} ) . \qquad ( 9 )$$

So in the pure delay case when F(s)=e^{-αs} is the desired transfer function, let

$$c = {e}^{\frac{α}{τ}} and r = \frac{α}{β} ,$$

so that

$${F}^{′} ( s ) = {e}^{- α ( \frac{1}{β} {W}_{0} ( ds ) - \frac{1}{τ} )} = {ce}^{- {rW}_{0} ( ds )} = {c ( \frac{{W}_{0} ( ds )}{ds} )}^{r} \qquad ( 10 )$$

is the required transfer function. Then we can numerically find the Padé approximants by using the Taylor series of (10).

$${F}^{′} ( s ) = c {\sum }_{i = 0}^{∞} \frac{{r ( i + r )}^{i - 1}}{i !} {( - ds )}^{i} \qquad ( 11 )$$

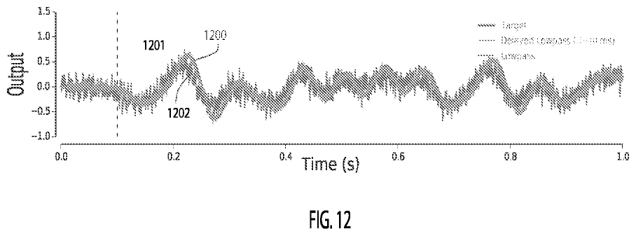

As shown in FIG. 12 an instance of this embodiment can be used to provide a better approximation of an ideal delay (1200) if the synapses themselves include a delay (1201), than the previous embodiment that only assumed a first-order linear filter (1202). Because the synapses include a 10 ms delay, this result demonstrates that these methods can be used to amplify the low-level synaptic delay 10-fold, while resulting in an improvement of 3× on normalized root-mean-square error (NRMSE).

### Method 2: Direct Solution

Consider the Laplace transform of some k-order synapse:

$$H ( s ) = \frac{1}{{\sum }_{i = 0}^{k} {c}_{i} {s}^{i}}$$

We wish to implement the desired nonlinear dynamical system:

\dot{x}=ƒ(x,u)
using this synaptic filter. Letting w(t)=ƒ′(x, u) and observing that in the actual system x(t)=(w*h)(t), we can write these dynamics in the Laplace domain:

$$\frac{X ( s )}{W ( s )} = \frac{1}{{\sum }_{i = 0}^{k} {c}_{i} {s}^{i}} ⇔ W ( s ) = X ( s ) {\sum }_{i = 0}^{k} {c}_{i} {s}^{i} = {\sum }_{i = 0}^{k} {c}_{i} [ X ( s ) {s}^{i} ]$$

since s is the differential operator. So the required function ƒ′(x, u) for the recurrent connection, for any synapse, is:

$${f}^{′} ( x , u ) = {\sum }_{i = 0}^{k} {c}_{i} {x}^{( i )} , \qquad ( 12 )$$

where x⁽ⁱ⁾ denotes the i^{th} derivative of x(t).

In the discrete case x[t+1]=ƒ(x, u):

$${f}^{′} ( x , u ) = {\sum }_{i = 0}^{k} {\overline{c}}_{i} x [ t + i ] . \qquad ( 13 )$$

The proof for the discrete case is similar by use of the time-shift operator with the z-transform.

For the generalized alpha synapse (i.e., double exponential), we find

$$H ( s ) = \frac{1}{( {τ}_{1} s + 1 ) ( {τ}_{2} s + 1 )} = \frac{1}{{τ}_{1} {τ}_{2} {s}^{2} + ( {τ}_{1} + {τ}_{2} ) s + 1} ⇒ {f}^{′} ( x , u ) = x + ( {τ}_{1} + {τ}_{2} ) \dot{x} + {τ}_{1} {τ}_{2} \ddot{x} = x + ( {τ}_{1} + {τ}_{2} ) f ( x , u ) + {τ}_{1} {τ}_{2} ( \frac{\partial f ( x , u )}{\partial x} f ( x , u ) + \frac{\partial f ( x , u )}{\partial u} \dot{u} ) . \qquad ( 14 )$$

This approach requires us to differentiate the desired system. If we are dealing with linear systems, then we can do this analytically to obtain a closed-form expression.

By induction it can be shown that:

$${x}^{( i )} = {A}^{i} x + {\sum }_{j = 0}^{i - 1} {A}^{i - j - 1} {Bu}^{( j )} .$$

Then by expanding and rewriting the summations:

$$\begin{matrix}{f}^{′} ( x , u ) = {\sum }_{i = 0}^{k} {c}_{i} {x}^{( i )} \\ = {\sum }_{i = 0}^{k} {c}_{i} [ {A}^{i} x + {\sum }_{j = 0}^{i - 1} {A}^{i - j - 1} {Bu}^{( j )} ] \\ = {\underbrace{( {\sum }_{i = 0}^{k} {c}_{i} {A}^{i} )}}_{Recurrent Matrix} x + {\sum }_{j = 0}^{k - 1} {\underbrace{( {\sum }_{i = j + 1}^{k} {c}_{i} {A}^{i - j - 1} ) B}}_{Input Matrices} {u}^{( j )}\end{matrix} . \qquad ( 15 )$$

This gives a matrix form for any LTI system with a k-order synapse, provided we can determine each u^{(j)} for 0≤j≤k−1.

As a demonstration, we can apply the above formula to the generalized alpha synapse, giving the following expression for any linear system:

ƒ′(x,u)=(τ₁τ₂A²+(τ₁+τ₂)A+I)x+(τ₁+τ₂+τ₁τ₂A)Bu+τ₁τ₂B\dot{u}.

### Example Embodiment: Synaptic Heterogeneity

Past work has not shown how to take advantage of having a variety of different synaptic filters within the implemented network. The methods described in this section address this general problem. Some of these modifications improve network accuracy for performing dynamic computation.

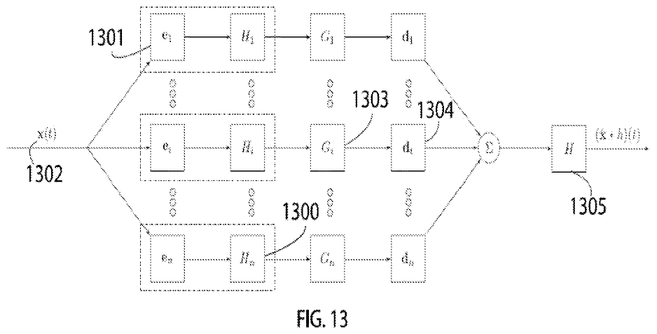

Introducing heterogeneous filters into the NEF significantly extends these methods. As shown in FIG. 13 we can introduce an “encoding filter” Hᵢ (1300) after the standard NEF encoder eᵢ (1301) that is distinct for each neuron and provides a specific processing of the time-varying vector x(t) (1302). The filter signal projects through the neural nonlinearity Gᵢ (1303) resulting in neural activity that is decoded with linear decoders dᵢ (1304) and filtered by a standard NEF filter H (1305). In essence we have factorized the dynamics into encoding and decoding filters in a manner analogous to the factorization of the weight matrix into decoders and encoders in the NEF.

In the NEF, there is a single synaptic filter per projection between ensembles, resulting in the encoding given by:

δᵢ=Gᵢ[<eᵢh(t)*x(t)>+Jᵢ].
where δᵢ is the neural activity (rates or spikes) from neuron i, and Jᵢ is a bias current. Here we have introduced the notion of defining one or more synaptic filter per neuron, as is shown in FIG. 13, giving:

δᵢ=Gᵢ[hᵢ(t)*<eᵢx(t)>+Jᵢ],
or per dimension in the input space

δᵢ=Gᵢ[<eᵢhᵢ(t)*x(t)>+Jᵢ],
where hᵢ(t) is a vector of D filters applied to their respective dimensions in the D-dimensional input vector x (t). This provides a wider variety of “temporal features” that are encoded by the neural population, allowing us to extend the NEF in a manner that provides better implementation of a broad class of dynamical computation.

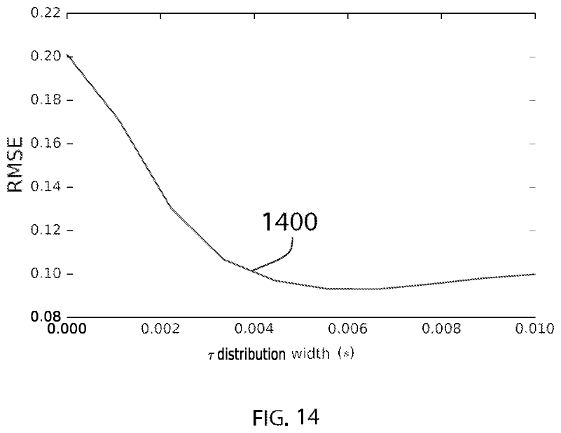

In our example embodiment, we use heterogeneous first-order linear filters, but the methods apply to any linear filters. Here, we employ these methods to compute the differentiation operator. Specifically, we approximate the filter H(s)=2τs/(τs+1). This is the derivative s multiplied by a low-pass 1/(τs+1) (to make it causal) and scaled by 2τ for normalization. We simulate a network of 1000 spiking neurons with 15 Hz white noise input, and vary the width of the distribution for the time constants of the input filters for each neuron. The time constants are picked from an even distribution with a lower bound of 0.2 ms and an upper bound that varies up to 10 ms. FIG. 14 shows the results of these simulations, that demonstrate the importance of having a variety of time constants. Root mean-square-error (RMSE) is shown as a function of the change in distribution width (1400). In this instance, the optimal width is approximately 6 ms. Notably, the RMSE drops in half at the optimal value. Because there exists an optimal value, it is clear that the distribution is playing an important role (i.e., it is not merely because longer synapses are being introduced). Thus this extension to the NEF improves the ability of these networks to compute dynamical functions.

### DISCUSSION

The embodiments demonstrated here show the ability to compute a variety of linear and nonlinear dynamic functions, including accurate casual and acausal filters. Examples include specific applications to delays, discrete implementation, spectrographic power, derivatives, and Fourier transforms. Additional embodiments extend these results by showing how to employ a wide variety of synaptic filters, and how to exploit heterogeneous distributions of synaptic filters.

The example results shown demonstrate that the methods described in this invention allow us to improve RMSE and computation time compared to state-of-the-art approaches, and also show the applicability of these methods to a wide variety of neural networks, both spiking and non-spiking, for performing dynamical computation.

The methods described here can be used to develop additional embodiments not described in detail. These include exploitation of intrinsic neuron dynamics, such as using intrinsically bursting neurons to more efficiently implement oscillatory networks, or adapting neurons to more efficiently and accurately compute differentiation. Similarly, these methods can support dynamic processing, such as prediction (which reduces to differentiation for a wide variety of cases, e.g., as is evident from the Taylor series expansion of functions). Some of the examples provided can be directly combined, such as using a controlled delay bank of filters for trajectory generation to produce useful networks. As well, the employment of nonlinear synaptic filters and nonlinear mixing of delays can be accomplished through direct applications of these methods.

1. A computer implemented method for implementing an artificial neural network for dynamic computing applications, the artificial neural network comprising a plurality of nodes, each node having an input and an output; the method comprising:
defining a node response function which receives varying inputs over time at each node input and produces varying outputs over time at each node output;
defining at least one temporal filter associated with each node input and/or output;
using the node response function and each said temporal filter to determine connection weights between layers of nodes in the artificial neural network;
computing a dynamic function based on the determined connection weights between layers of nodes in the artificial neural network.
